(19) United States
(12) Patent Application Publication
(10) Pub. No.: US 2010/0011067 A1
(43) Pub. Date: Jan. 14, 2010

(54) Transmitter Instant Messaging Interface in a Distributed Control System

(76) Inventor: Peter E. Allstrom, Attleboro, MA (US)

Correspondence Address: Richard L. Sampson;SAMPSON & ASSOCIATES. P.C., 50 Congress Street, Boston, MA, 02109, US

(21) Appl. No.: 12/170,977

(22) Filed: Jul. 10, 2008

(51) Int. Cl. G06F 15/16

(52) U.S. Cl. 709/206

(57) ABSTRACT

A distributed process control system and method, includes a control component, a field device, and a process control network communicably coupling the control component to the field device. A first instant messaging (IM) component and IM user interface is associated with the control component, a second IM component and IM user interface is associated with the field device. The first and second IM components are configured to enable users respectively located at the control component and the field device to generate, send and receive IM communications via the process control network.

### BACKGROUND

1. Technical Field

This invention relates to control systems and, more particularly, to in-band Instant Messaging between users at nodes of a distributed process control network.

2. Background Information

The terms “control” and “control systems” refer to the control of the operational parameters of a device or system by monitoring one or more of its characteristics. This is used to insure that output, processing, quality and/or efficiency remain within desired parameters over the course of time.

Control is used number of fields. Process control, for example, is typically employed in the manufacturing sector for process, repetitive and discrete manufactures, though it also has wide application in electric and other service industries. Environmental control finds application in residential, commercial, institutional and industrial settings, where temperature and other environmental factors must be properly maintained. Control is also used in articles of manufacture, from toasters to aircraft, to monitor and control device operation.

Control systems typically utilize field devices, including sensors and the like, which are integrated into the equipment being controlled. For example, temperature sensors are usually installed directly on or within the articles, bins, or conduits that process, contain or transport the materials being measured. Control devices such as valves, relays, and the like, must also be integrated with the equipment whose operations they govern.

The I/A Series process control systems, manufactured by the assignee hereof, utilize an architecture which typically includes a workstation providing a monitoring and control interface for operations and maintenance staff. Control algorithms may be executed in one or more control processors (CPs), with control achieved via fieldbus modules (FBMs) that connect to Field Devices (FDs), such as transmitters or Programmable Logic Controllers (PLCs), and sensors or valves associated with the physical equipment to be operated. Various software packages associated with data historians provide historical tracking of plant data, alarming capabilities, operator action tracking, and status of all stations on the process control system network.

A frequent consequence of the highly distributed nature of these process control systems is that a control room housing the workstation and operational/monitoring personnel, may be located at relatively large distances from many of the field devices. Maintenance and/or replacement of the individual field devices often requires coordination between the control room and maintenance staff working in the field. The distances between these locations, which in some applications may be measured in kilometers, tends to complicate this coordination.

This coordination between control room and field personnel may be accomplished by the use of voice communication over radios, cell phones, etc. However, noisy process control environments may make such communication difficult. Text messaging using cell phones or wireless Internet-connected PDAs and the like may be used in some environments, though RF interference may limit their efficacy in other process environments. The use of cell phones or PDAs or other relatively high powered devices may also be undesirable in potentially volatile process environments requiring the use of intrinsically safe equipment. In addition, these communications tend to be difficult to capture and archive, such as for future diagnostic purposes.

While Instant Messaging (IM) has been used in process control environments, it has generally been limited to sending alerts to locations outside the process control network, via the Internet, such as to notify on-call personnel of problems with a network device. See, for example, European Patent Application EP 1420316, which discloses the use of IM to send messages to a user's hand-held device. US Patent Publication No. US2007/265712 discloses process control elements having “direct connections to the Internet. US Patent Publication No. US2006/186986 discloses a method in which devices generate and transmit status communications via IM.

A need exists for an improved system and method for enabling communications between personnel in a process control environment, without the need to carry or introduce new communication apparatus into the environment.

### SUMMARY

In one aspect of the present invention, a distributed process control system, includes a control component, a field device, and a process control network communicably coupling the control component to the field device. A first instant messaging (IM) component and IM user interface is associated with the control component, a second IM component and IM user interface is associated with the field device. The first and second IM components are configured to enable users respectively located at the control component and the field device to generate, send and receive IM communications via the process control network.

Another aspect of the invention includes a method of enabling user communication in a distributed process control system. The method includes communicably coupling a control component to a process control network, and communicably coupling a field device (FD) to the process control network. A first instant messaging (IM) component and IM user interface is associated with the control component, and a second IM component and IM user interface is associated with the FD. The first and second IM components and IM interfaces are configured to enable users respectively located at the control component and the FD to generate, send, and receive IM communications via the process control network.

A further aspect of the invention includes an article of manufacture for enabling user communication in a distributed process control system. The article of manufacture includes a computer usable medium having a computer readable program code embodied therein, for communicably coupling a control component to a process control network, and communicably coupling a field device (FD) to the process control network. Computer readable program code is also provided for associating a first instant messaging (IM) component and IM user interface with the control component, associating a second IM component and IM user interface with the FD, and configuring the first and second IM components and IM interfaces to enable users respectively located at the control component and the FD to generate, send, and receive IM communications via the process control network.

In a still further aspect of the invention, a distributed industrial process control system includes a control component, a transmitter, a data historian, and an industrial process control network running a protocol selected from the group consisting of FoxCom, HART, Foundation Field Bus, Modbus, Profibus, Zigbee™ (IEEE 802.15.4), DeviceNet, ControlNet, Ethernet/IP, DH+, Intranet, and combinations thereof The process control network is communicably coupled to the control component, the transmitter, and the data historian. A first instant messaging (IM) component and IM user interface, is associated with the control component. A second IM component and IM user interface is disposed within a handheld configurator directly coupled to the transmitter, the transmitter being a multi-function communication device configured as both a process data transmitter, and as a network access point for two-way human-language IM communications, using the network protocol. The first and second IM components are configured to enable users respectively located at the control component and the transmitter to form a chat room session to generate, send and receive human-readable IM communications via the network protocol, independently of any external networks. The data historian is configured to record the IM communications.

The features and advantages described herein are not all-inclusive and, in particular, many additional features and advantages will be apparent to one of ordinary skill in the art in view of the drawings, specification, and claims. Moreover, is should be noted that the language used in the specification has been principally selected for readability and instructional purposes, and not to limit the scope of the inventive subject matter.

### BRIEF DESCRIPTION OF THE DRAWINGS

FIG. 1 is schematic diagram of a process control system, with optional portions shown in phantom, within which embodiments of the present invention may be deployed;

FIG. 2 is a schematic diagram of aspects of an embodiment of the present invention useful in the process control system of FIG. 1;

FIG. 3 is a schematic diagram similar to that of FIG. 2, of an alternate embodiment of the present invention;

FIG. 4 is a screen shot of another aspect of the embodiments of FIGS. 2 and 3;

FIG. 5 is a plan view of a module optionally usable with the embodiments of FIGS. 2-4;

FIG. 6 is flow chart of a method associated with embodiments of the present invention; and

FIG. 7 is a view similar to that of FIG. 1, of another process control system within which embodiments of the present invention may be deployed.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

Where used in this disclosure, the term “computer” is meant to encompass a workstation, personal computer, personal digital assistant (PDA), wireless telephone, or any other suitable computing device. A “fieldbus” is a digital, two-way, communication link among intelligent measurement and control devices, and serves as a local area network (LAN) for advanced process control, remote input/output and high speed factory automation applications. Terms such as “component,” “control components/devices,” “messenger component or service,” and the like are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server (or control related devices) can be components. One or more components may reside within a process and/or thread of execution and a component may be localized on one computer and/or distributed between two or more computers or control devices.

Embodiments of the system and method of the present invention can be programmed in any suitable language and technology, including, but not limited to: C++; Visual Basic; Java; VBScript; Jscript; BCMAscript; DHTM1; XML and CGI Hypertext Markup Language (HTML), Active ServerPages (ASP) and Javascript. Alternative versions maybe developed using other programming languages. Any suitable database technology can be employed, including, but not limited to: Microsoft Access and IMB AS 400.

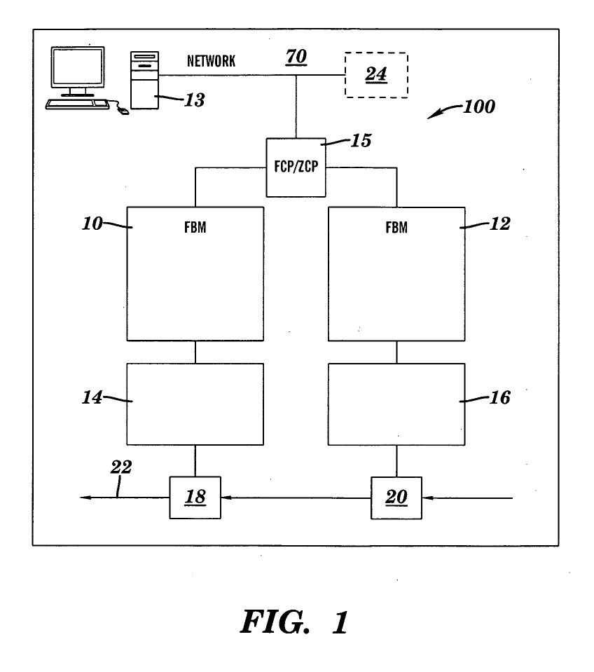

Referring to FIG. 1, a distributed process control system 100 is shown, within which representative embodiments of the present invention may be deployed. Process control system 100 includes one or more Field Bus Modules (FBMs) 10, 12 that communicate with one or more Field Devices (FDs) 14, 16 using any one or more of various communication protocols. The system 100 may includes a controller/workstation 13 which provides a monitoring and control interface for operations and maintenance staff. Control algorithms and/or supervisory functions may be implemented in one or more control processors (CPs) 15, which are communicably coupled to the FBMs 10, 12 to achieve control via the FDs 14, 16 and sensors 18, 20, associated with the physical equipment/process 22. System 100 may optionally include a data historian 24 configured to capture and record various data associated with the system 100 and process 22.

In particular exemplary, non-limiting embodiments, system 100 includes an I/A Series® (Invensys) process control system, with CP 15 including an FCP (or ZCP) 270 Control Processor available from Invensys. The FBMs 10, 12 may be conventional FBM 233 field bus modules, while the FDs 14, 16 may be conventional single or multivariable transmitters such as IMV 30 pressure transmitters, all available from Invensys, and which are modified in accordance with the teachings of the present invention. In other embodiments, the FDs may be conventional Programmable Logic Controllers (PLCs). The FDs may be communicably coupled to any number of sensors 18, 20 associated with a process 22 (such as to measure flow through a conduit).

The present invention relates to systems and methods in which the process control system 100 is configured to provide human-discernable multi-directional communications in-band (i.e., over the existing process control network), using system components. Embodiments of the present invention thus relate to a system and methodology that enable multiparty communications in substantially real-time in a networked industrial controller environment. This in-band communication is provided to facilitate various system (e.g., servicing) functions, such as diagnosis, status, and troubleshooting among various parties located at various nodes within the system/network. In one aspect of the present invention, messaging components may be installed on local control components, such as control room workstation 13, and on remote field equipment, such as the FDs 14, 16. In this manner, parties located in the field, such as maintenance personnel, may conveniently effect in-band, real-time communication with control room personnel, without the need for separate communications equipment. In this manner, diagnosis, troubleshooting, and/or routine maintenance can be performed collaboratively among various parties.

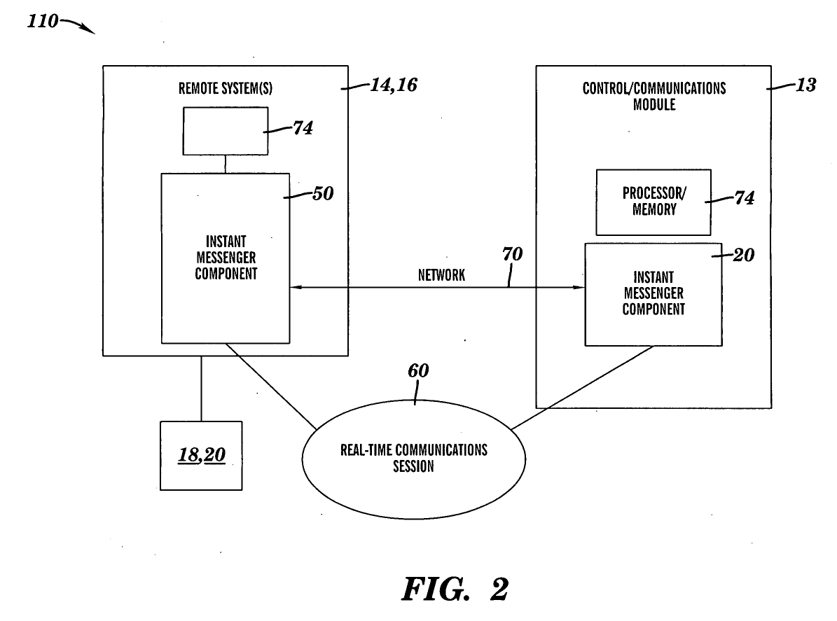

In particular embodiments, a controller (control room component) 13 and transmitter 14, 16 are provided with an “Instant Messaging” (IM) component 20, 50 (FIG. 2) to enable an operator in a control room to communicate via the control system network 70. The IM may be sent using the transmitter protocol (e.g., FoxCom, HART, Foundation Field Bus, Profibus, Modbus, Zigbee™ (IEEE 802.15.4), etc.) of the process control system. This approach tends to eliminate the need for voice communication over radios, cell phones, etc., which may be difficult due to noisy process control environments, as discussed hereinabove. This approach also provides for convenient recordation and archiving of communications by a process historian 24, for diagnostics, etc.

Referring to FIG. 2, system portion 110 illustrates aspects of system 100 (FIG. 1), including message components 20, 50 in accordance with embodiments of the present invention. Instant Messenger component 20 may be a conventional IM component (e.g., MSN Messenger) which has been adapted to run on an industrial controller/workstation 13 such as typically deployed in control rooms of process control systems such as system 100 (FIG. 1). Similarly, a remote system or field device 14, 16, such as a single or multivariable transmitter, is operatively associated with an Instant Messenger component 50, which may also be an otherwise conventional IM component that has been adapted to operate in connection with field devices 14, 16. Both IM components 20, 50 are configured to enable control component (controller) 13 remote devices 14, 16 to exchange information over network 70 (e.g., using the process control protocol native to network 70). A user located at remote (field) device 14, 16 may thus establish a real time IM communications session 60, such as a chat room session, with the controller 13 (or vice versa). In this manner, users in the field, such as maintenance personnel, may use the very devices being serviced (e.g., FDs 14, 16) to notify an operator at controller 13 of a pending problem, procedure, or other status, via messages or codes displayed or provided in the communications session 60. Since the communications session 60 is bidirectional (multi-directional if other parties/devices are involved), the operator at controller 13 may access controller information as desired in order to perform further diagnosis or send commands such as a shut-down command, for example, or initiate further procedures such as troubleshooting and/or corrective actions.

It is noted that controller(s) 13 can communicate to a plurality of remote devices 14, 16, etc., across a local factory network 70 (e.g., running FoxCom, HART, Foundation Field Bus, Profibus, Modbus, Zigbee™ (IEEE 802.15.4), DeviceNet, ControlNet, Ethernet/IP, DH+, Intranet, and/or other protocols). Moreover, although it may be desirable to avoid wireless transmissions in some applications, it should be understood that the IM communications provided in accordance with the present invention may include wireless interactions without departing from the scope of the present invention. For example, portions of the communication on network 70 may take place via short, medium or long range protocols such as Bluetooth, WiFi, cellular, etc.

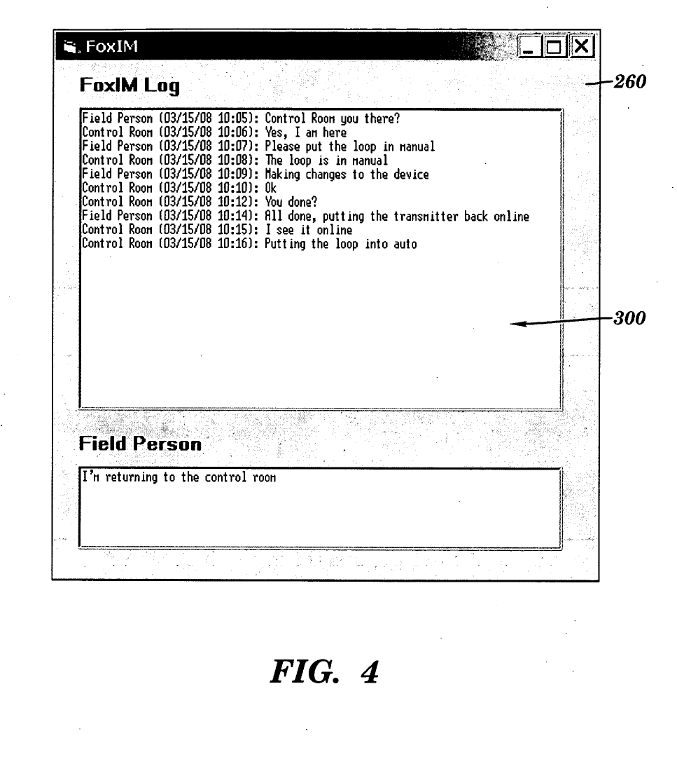

As also shown, processors 74 associated with the controllers 13 and FDs 14, 16, may execute from an associated memory sub-system that may include any suitable operating system (e.g., custom-designed Invensys I/A OS, Microsoft® Windows® NT/2000/XP/Vista, Windows CE, Linux, .NET, OS-9, UNIX, VRTX, QNX, VxWorks, CE.NET, etc.). The field devices 14, 16 may communicate with various Input/Output subsystems 18, 20. These I/O subsystems/devices may include sensors and/or other networks (e.g., Analog, Digital, Programmed/Intelligent I/O modules, programmable controllers, communications modules, networks). It is to be appreciated that the I/O subsystems 18, 20 may also be similarly adapted for message communications, and may therefore participate in the communications session 60. For example, IM component 50 may be disposed within an I/O system 18, 20 in the form of a hand-held device (e.g., a Configuration tool) that may be coupled directly to the FD 14, 16, as discussed hereinbelow with respect to FIG. 4.

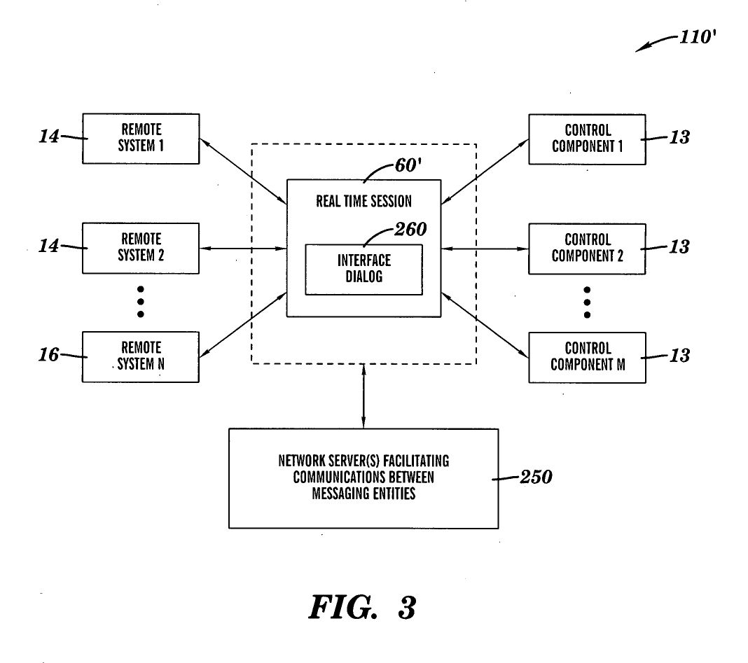

Referring now to FIG. 3, a system 110′ illustrates a real time message session 60′ in accordance with an alternate aspect of the present invention. One or more remote devices (FDs) 14, 16, etc., may participate in the real time message session 60′ with one or more control components 13 configured with IM components as discussed hereinabove. The control components 13 may include a workstation, communications modules, intelligent modules, network modules, software modules, and the like. A network server 250 (or servers), which may, for example, be associated with one or more of the control components 13, may be used to facilitate the IM communications between the remote systems 14, 16 and the control components 13. In this regard, respective entities illustrated in the system 110′ are adapted with the IM message components 20, 50 (FIG. 2) for initiating and/or participating in the real time session (60, 60′). It is to be noted that the sessions 60, 60′, although being instantiated on the process control network 70, may be supported by one or more of the following Internet-related standards: an RFC 1459 Internet Relay Chat Protocol, an RFC 2810 Internet Relay Chat: Architecture, an RFC 2811 Internet Relay Chat: Channel Management, an RFC 2812 Internet Relay Chat: Client Protocol, and an RFC 2813 Internet Relay Chat: Server Protocol.

In operation of particular embodiments, the network server 250 receives a request to establish the session 60, 60′ from one or more of the entities 13, 14, 16, etc., and drives an interface dialog 260 to the entity making the request, which is displayed on the screen of workstation 13 and on screen 510 to effectively serve as an IM user interface for both users at the control components 13 and remote FDs 14, 16, respectively. The network server 250 then contacts or notifies one or more other entities that have been requested (13, 14, 16, etc.,) to establish the session 210. It is noted that even though an entity may not have responded to a request, that the interface dialog 260 may still be presented to the requesting party; wherein information can be provided to or exchanged with the interface dialog 260 for future reference employable by a non-responding or late-responding parry. When the session 210 has been established, respective entities are provided with the interface dialog 260 in order to exchange information therein in a substantially real time manner. Such information can include automated information driven from the respective systems 14, 16 and/or control components 13, and/or can include user/system-driven information such as an exchange of type-written messages, voice encoded messages, diagrams, video clips or video data, pictures, sounds, symbols, icons, emoticons, reports, files, procedures, manuals, hypertext links, web information, factory information, status data, control data, configuration data, mathematical data, program data, and/or substantially any information, data, data type, and/or format. It is also noted that any of the entities 13, 14, 16, etc., may be used to initiate and/or participate in the session 60, 60′.

Turning now to FIG. 4, interface dialog 260 is shown with a chat session 300 in accordance with an aspect of the present invention. It is to be appreciated that chat session 300 is exemplary in nature and is not intended to limit the scope of the present invention to the particular aspects depicted. In this example, a user in the field (at an FD 14, 16) initiates the chat session 300 with a user in the control room (at a workstation 13). It is noted that the party initiating the chat session 300 may contact one or more other parties, if desired, and/or one or more of the parties participating in the chat session 300 can contact additional parties if desired and bring those additional parties into the chat session.

As shown, in session 300, the field user may initially seek confirmation from the control room user that the session 300 is operational, and then ask the control room user to place the FD in (e.g., off-line) condition to be serviced. The field user may then service the FD and then inform the control room user upon completion. The control room user may then place the FD back on-line and communicate this status of FD 14, 16 to the field user. Thus, in this example, the field user may verify that the FD is ready for servicing, implement the servicing, and then verify the success of the servicing, without any extraneous trips to the control room housing control component 13. Moreover, this may be accomplished by communicating in real-time, using the process control system 100 itself.

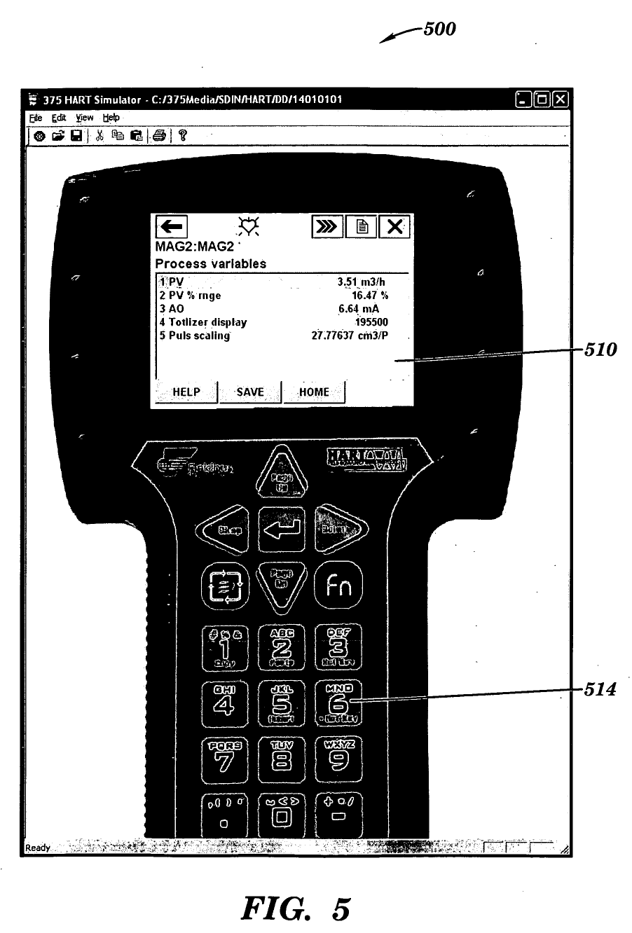

As mentioned above, in particular embodiments, the IM component 50 (or portions thereof), associated with field devices 14, 16 may be disposed within a device 18, 20 communicably coupled to the FD. For example, turning now to FIG. 5, IM component 50 may be disposed within an I/O device in the form of a hand held terminal 500, such as a conventional 375 Hand Held Configurator (Emerson Electric, St. Louis, Mo.), which is directly couplable to a field device 14, 16, e.g., by cable or wirelessly by Bluetooth®, etc. As shown, the hand held terminal 500 includes a user interface display 510 for displaying the interface dialog 260, which may include status, sent and received messages, and/or other options associated with the various components described above. The display 510 in a simple example may provide a command type prompt to exchange messages via the instant messaging protocol. The display 510 may include one or more display objects reflecting various options and/or status indications which are described in more detail below. Such display options can include input boxes, sliders, icons, menus, buttons, selection options, tabs, pictures, colors, associated sounds, and so forth. As can be appreciated the hand held device 500 can include various buttons as illustrated at 514, inputs such as keyboards and/or a mouse, and may include such aspects as voice recognition software and associated microphone for interacting with the display 510. Furthermore, the display 510 may be provided as a graphical user interface (GUI).

Substantially any desired message and/or data transfer mechanisms may be employed for communications in accordance with embodiments of the present invention. For example, message information may be transferred using the aforementioned Internet-related protocols (or variations thereof), while data may be transmitted in the form of binary or other type data packets that convey information in accordance with the present invention.

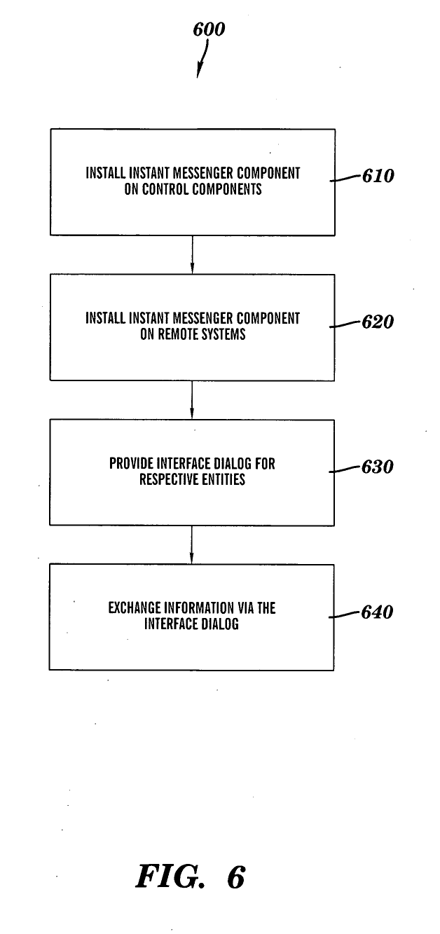

Referring now to FIG. 6, flow diagram 600 is illustrative of an aspect of the instant messaging communications in accordance with an aspect the present invention are discussed. While, for purposes of simplicity of explanation, the methodologies are shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

As shown, at 610, instant messenger components 20, as discussed above, are installed on one or more control components 13, such as controllers and/or configurators associated with a control room workstation. Similarly, instant messenger components 50 are installed 620 or otherwise associated with one or more remote network devices at 14, 16, such as single or multivariable transmitters, computers, hand held devices such as configurator 500, laptops, and substantially any remote device capable of communications with network 70 and having capabilities of running the messenger component. At 630, an interface dialog 260 (FIG. 3) is provided for the respective communications entities described above in order to provide input and output capabilities for transmitting and receiving data between the respective entities. At 640, information is exchanged between control components 13 and/or remote systems 14, 16 via the interface dialog 260, e.g., in a chat session 60, 60′ (FIGS. 2, 3) and/or other suitable interface to exchange data between entities.

Thus, as shown and described hereinabove, all IM traffic, i.e., traffic between the control component 13 and the FDs 14, 16, occurs in-band, i.e., within the process control network 70. This approach also eliminates the need for a separate communication device(s) and/or network(s) in order for control room and field personnel to communicate, e.g., during servicing of FDs. This in-band approach tends to simplify servicing operations for field personnel, by eliminating the need to carry additional communication devices, while providing a relatively efficient use of resources by effectively multi-tasking using existing infrastructure. Moreover, as mentioned above, this approach tends to be advantageous in many process environments where the use of high power devices may be undesirable, while also enabling the IM communications to be easily captured and archived in process historian 24 (FIG. 1).

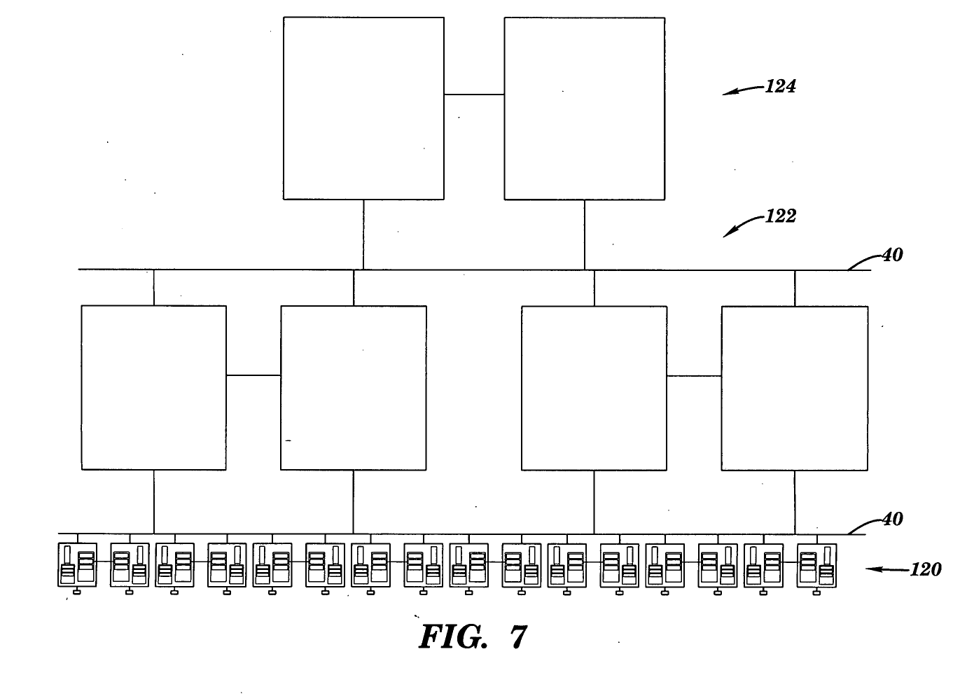

Moreover, although the foregoing embodiments have been shown and described as having a single controller/workstation 13 and a pair of FDs 14, 16, it should be recognized that aspects of the present invention may be applied to process control systems and apparatus of substantially any number of components. For example, a process control system in which the invention is employed in a plurality of pairs of FDs 120, FBMs 122 and CPs 124 is illustrated in FIG. 7.

Referring now to the following Table I, a method of interfacing redundant devices to a distributed control system, in accordance with the present invention, is shown and described.

TABLE I

| | |
|---|---|
| 400 | Couple a control component to the control network |
| 402 | Couple a field device to the control network |
| 404 | Associate a first IM component and IM user interface with |
| | the control processor |
| 406 | Associate a second IM component and IM user interface |
| | with the field device |
| 408 | Configure the first and second IM components and IM user |
| | interfaces to enable users respectively located at the control |
| | processor and the FD to generate, send, and receive IM |
| | communications via the process control network |

At 400, a control component/workstation is communicably coupled to the control network 70. A field device is coupled to the network 70 at 402. At 404, a first IM component and IM user interface is associated with the control component. At 406, a second IM component and IM user interface is associated with the field device. The first and second IM components and IM user interfaces are configured at 408, to enable users respectively located at the control component/workstation and the FD to generate, send, and receive IM communications via the process control network.

It should be understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having thus described the invention, what is claimed is:

1. A distributed process control system, comprising:
a control component;
a field device;
a process control network communicably coupling the control component to the field device;
a first instant messaging (IM) component and IM user interface, associated with the control component;
a second IM component and IM user interface, associated with the field device;
said first and second IM components configured to enable users respectively located at the control component and the field device to generate, send and receive IM communications via the process control network.

2. The system of claim 1, wherein the field device comprises a transmitter.

3. The system of claim 1, wherein the second IM component and IM user interface are disposed within a module directly coupled to the field device.

4. The system of claim 3, wherein the module comprises a handheld configurator directly connected to the field device.

5. The system of claim 1, being independent of the Internet.

6. The system of claim 5, wherein the IM communications are sent, transported, and received, independently of any communication outside of the process control system.

7. The system of claim 1, wherein the IM communications are independent of control instructions for the field device.

8. The system of claim 1, wherein the IM communications are human-readable.

9. The system of claim 1, wherein the IM communications are user-generated.

10. The system of claim 1, wherein the first and second IM components are configured to form a chat room session.

11. The system of claim 10, wherein the IM communications is selected from the group consisting of type-written messages, voice encoded messages, diagrams, video data, pictures, sounds, symbols, icons, emoticons, reports, files, procedures, manuals, hypertext links, web information, factory information, status data, control data, configuration data, mathematical data, en program data, and combinations thereof.

12. The system of claim 1, wherein the process control network is configured to run a protocol selected from the group consisting of FoxCom, HART, Foundation Field Bus, Modbus, Profibus, Zigbee™ (IEEE 802.15.4), DeviceNet, ControlNet, Ethernet/IP, DH+, Intranet, and combinations thereof.

13. The system to claim 1, wherein the first and second IM components are configured to send and receive IM communications using a protocol selected from the group consisting of FoxCom, HART, Foundation Field Bus, Modbus, Profibus, Zigbee™ (IEEE 802.15.4), DeviceNet, ControlNet, Ethernet/IP, DH+, Intranet, and combinations thereof.

14. The system of claim 1, wherein the process control network is an industrial process control network.

15. The system of claim 1, further comprising a data historian communicably coupled to the process control network.

16. The system of claim 15, wherein the data historian is configured to record the IM communications.

17. The system of claim 1, wherein the field device is configured to serve as both a field device within a process control system, and as a network access point for an IM client, wherein user-generation and receipt of IM messages is enabled at the field device and at the control component.

18. A method of enabling user communication in a distributed process control system, the method comprising:
(a) communicably coupling a control component to a process control network;
(b) communicably coupling a field device (FD) to the process control network;
(c) associating a first instant messaging (IM) component and IM user interface with the control component;
(d) associating a second IM component and IM user interface with the FD;
(e) configuring the first and second IM components and IM interfaces to enable users respectively located at the control component and the FD to generate, send, and receive IM communications via the process control network.

19. The method of claim 18, wherein said communicably coupling (b) comprises communicably coupling a transmitter to the process control network.

20. The method of claim 18, comprising communicably coupling a data historian to the process control network.

21. The method of claim 20, comprising recording the IM communications in the data historian.

22. The method of claim 18, comprising disposing the second IM component and IM user interface in a module directly couplable to the field device.

23. The method of claim 22, comprising disposing the second IM component and IM user interface in a handheld configurator directly couplable to the field device.

24. The method of claim 18, comprising providing an interface dialog for the IM communications.

25. The method of claim 24, comprising exchanging information via the interface dialog.

26. An article of manufacture for enabling user communication in a distributed process control system, the article of manufacture comprising:
a computer usable medium having a computer readable program code embodied therein, said computer usable medium having:
computer readable program code for:
(a) communicably coupling a control component to a process control network;
(b) communicably coupling a field device (FD) to the process control network;
(c) associating a first instant messaging (IM) component and IM user interface with the control component;
(d) associating a second IM component and IM user interface with the FD;
(e) configuring the first and second IM components and IM interfaces to enable users respectively located at the control component and the FD to generate, send, and receive IM communications via the process control network.

27. A distributed industrial process control system, comprising:
a control component;
a transmitter;
a data historian;
an industrial process control network running a protocol selected from the group consisting of FoxCom, HART, Foundation Field Bus, Modbus, Profibus, Zigbee™ (IEEE 802.15.4), DeviceNet, ControlNet, Ethemet/IP, DH+, Intranet, and combinations thereof,
the process control network communicably coupled to the control component, the transmitter, and the data historian;
a first instant messaging (IM) component and IM user interface, associated with the control component;
a second IM component and IM user interface disposed within a handheld configurator directly coupled to the transmitter;
the transmitter being a multi-function communication device configured as both a process data transmitter, and as a network access point for two-way human-language IM communications, using the network protocol;
said first and second IM components configured to enable users respectively located at the control component and the transmitter to form a chat room session to generate, send and receive human-readable IM communications via the network protocol, independently of any external networks; and
the data historian configured to record the IM communications.
